(19) United States
(12) Patent Application Publication
(10) Pub. No.: US 2011/0128251 A1
(43) Pub. Date: Jun. 2, 2011

(54) METHOD AND SYSTEM FOR DETECTING A CONTACT ON A TOUCH SCREEN

(75) Inventors: Pei XU, Shenzhen (CN); Yitong Zhao, Shenzhen (CN); Jie Zhang, Shenzhen (CN); Chen Huang, Shenzhen (CN); Yun Yang, Shenzhen (CN)

(73) Assignee: BYD COMPANY LIMITED, Shenzhen (CN)

(21) Appl. No.: 12/945,219

(22) Filed: Nov. 12, 2010

(30) Foreign Application Priority Data
Nov. 28, 2009 (CN) 200910188457.9

(51) Int. Cl. G06F 3/045

(52) U.S. Cl. 345/174

(57) ABSTRACT

A method of detecting a contact on a touch-screen panel including a plurality of touch-sensitive units arranged on a touch-sensitive surface. The method comprises receiving at least two induction signals induced by a contact of an object with the touch-sensitive surface at a point in between at least two adjacent touch-sensitive units. The at least two adjacent touch-sensitive units include a first touch-sensitive unit and a second touch-sensitive unit. The at least two induction signals include a first induction signal induced by contact with the first touch-sensitive unit and a second induction signal induced by contact with the second touch-sensitive unit. The method further comprises combining the first and second induction signals to produce at least part of a touch signal, and processing the touch signal to generate a control signal and outputting the control signal to a terminal application device to enable user to view data from coordinates of the contact point.

### CROSS-REFERENCE TO RELATED APPLICATION

This application claims foreign priority benefits under 35 U.S.C. §119 of Chinese Patent Application Serial No. 200910188457.9, filed on Nov. 28, 2009, the content of which is incorporated herein by reference in its entirety.

### BACKGROUND OF THE INVENTION

1. Technical Field

The present invention relates generally to a method for detecting a contact on a touch screen, and more particularly to a method for detecting a contact on a resistive touch screen.

2. Background

A touch screen generally includes capacitive touch screen, resistive touch screen and digital touch screen. There are varieties of resistive touch screen solutions, such as 4-wire, 5-wire and 8-wire touch screens. The most common resistive touch screen is 4-wire touch screen due to its low cost.

An example of a 4-wire touch screen 100 is shown in FIG. 1. The 4-wire resistive touch-screen panel includes a touch-sensitive surface with a plurality of touch-sensitive units. Each of the touch-sensitive units, such as touch-sensitive unit 1001, from top to bottom, includes a first transparent layer (not shown), a first conductive layer 102, an air-gap (not numbered), a second transparent layer (not shown), and a second conductive layer 110. When the touch-screen panel is not under an applied pressure, the air-gap keeps the first conductive layer 102 and the second conductive layer 110 apart. When a user touches surface of the touch screen with a stylus or finger, the pressure of the stylus or finger causes the first conductive layer 102 to deform, allowing the first conductive layer 102 and second conductive layer 110 to connect. In this manner, power may be applied to one of the first and second conductive layers through electrodes (e.g., 104_{—}a to 104_{—}b, or 112_{—}a to 112_{—}b) at opposing ends of that layer. The connection of the first layer 102 and the second layer 110 causes a change in electrical current or voltage, which may be registered as an event, or an interrupt signal, and sent to a microcontroller for processing.

When a user or a stylus touches one of the touch-sensitive units, X-Y coordinate positions of the touch point are conducted in a manner similar to a resistive voltage divider. The point of contact “divides” each layer with two resistors (e.g., R1 and R2) in series as shown in FIG. 2. To determine coordinates of the contact point, the voltage may be applied once in the vertical direction and then in the horizontal direction. That is, a supply voltage may be first applied to one layer and a measurement of the voltage across the other layer may be performed; and then, the supply voltage may be applied to the other layer and the opposite layer voltage may be measured. For example, if a supply voltage Vᵢₙ is applied to the first conductive layer 102 from the X-axis electrodes 104_{—}a to 104_{—}b, the X position of the touch point may be determined by the voltage Vₒᵤₜ between the electrodes 112_{—}a and 112_{—}b on the second conductive layer 110, represented by

$${V}_{out} = \frac{{Z}_{2}}{{Z}_{1} + {Z}_{2}} {V}_{in} .$$

Similarly, when the supply voltage Vᵢₙ is applied to the second conductive layer 110 from the Y-axis electrodes 112_{—}a to 112_{—}b, the Y position of the touch point may be determined by the voltage Vₒᵤₜ between the electrodes 104_{—}a and 104_{—}b on the first conductive layer 102.

As shown in FIG. 3, when a user or stylus touches a point P across multiple touch-sensitive units, such as 3001, 3002, 3003, and 3004, the output voltage of sub-point P1 on the touch-sensitive unit 3004 on one coordinate axis, e.g., on X-axis, may be determined by impedance in between the sub-points on adjacent touch-sensitive units. This is illustrated, for example, in FIG. 4. The output voltage of sub-point P1, which maybe indicative of the X position of the touch point, may be accordingly represented by

$${V}_{out} = \frac{{Z}_{2}}{{Z}_{11} + {Z}_{2}} {V}_{in} ,$$

where

$${Z}_{11} = \frac{{Z}_{3} + {Z}_{4} + {Z}_{5}}{{Z}_{1} + {Z}_{3} + {Z}_{4} + {Z}_{5}} {Z}_{1} .$$

The output voltage of touch point P in this case may not equal the output voltage of a touch point on a single touch-sensitive unit as illustrated in FIG. 1, which may result in inaccurate X-Y coordinate data of the touch point.

### SUMMARY OF THE INVENTION

According to one exemplary embodiment of the invention, a method for detecting a contact on a touch-screen panel is described. The touch-screen panel includes a plurality of touch-sensitive units arranged on a touch-sensitive surface. The method comprises receiving at least two induction signals induced by a contact of an object with the touch-sensitive surface at a point in between at least two adjacent touch-sensitive units. The at least two adjacent touch-sensitive units include a first touch-sensitive unit and a second touch-sensitive unit. The at least two induction signals include a first induction signal induced by contact with the first touch-sensitive unit and a second induction signal induced by contact with the second touch-sensitive unit. The method further comprises combining the first and second induction signals to produce at least part of a touch signal, and processing the touch signal to generate a control signal and outputting the control signal to a terminal application device to enable user to view data from the contact point.

According to one exemplary embodiment of the invention, a touch screen panel is described. The touch screen panel comprises touch-sensitive module including a plurality of touch-sensitive units arranged on a touch-sensitive surface. The touch-sensitive module is configured to receive at least two induction signals induced by a contact of an object with the touch-sensitive surface at a point in between at least two adjacent touch-sensitive units including a first touch-sensitive unit and a second touch-sensitive unit. The at least two induction signals include a first induction signal induced by contact with the first touch-sensitive unit and a second induction signal induced by contact with the second touch-sensitive unit. The touch screen panel further includes a calculating module configured to combine the first and second induction signals to produce a touch signal. The touch screen panel further includes a microcontroller configured to process the touch signal to generate a control signal and output the control signal to a terminal application device to enable user to view data from coordinates of the contact point.

### BRIEF DESCRIPTION OF THE DRAWINGS

The foregoing summary, as well as the following detailed description of the invention, will be better understood when read in conjunction with the appended drawings. The embodiments illustrated in the figures of the accompanying drawings herein are by way of example and not by way of limitation. In the drawings:

FIG. 1 illustrates a 4-wire resistive touch-screen panel according to the prior art;

FIG. 2 illustrates a schematic diagram of a voltage divider according to the prior art;

FIG. 3 illustrates a touch point across multiple touch-sensitive units on a 4-wire resistive touch-screen panel;

FIG. 4 illustrates a schematic diagram of a voltage divider according to FIG. 3;

FIG. 5 illustrates a schematic diagram of a touch-screen panel according to an exemplary embodiment of the present invention;

FIG. 6 is a flow chart describing a method of detecting a touch on a touch-screen panel according to one exemplary embodiment of the present invention;

FIG. 7A illustrates a touch point across multiple touch-sensitive units on a resistive touch-screen panel according to one exemplary embodiment of the present invention; and

FIGS. 7B and 7C illustrate schematic diagrams of touch points across multiple touch-sensitive units on a touch-screen panel according to exemplary embodiments of the present invention.

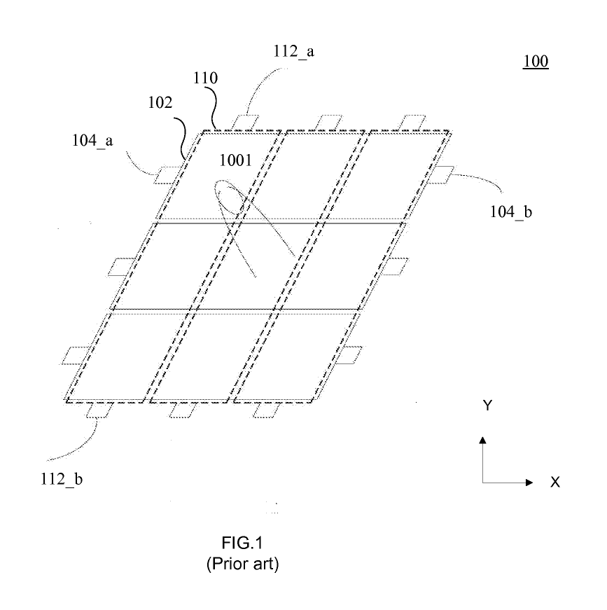

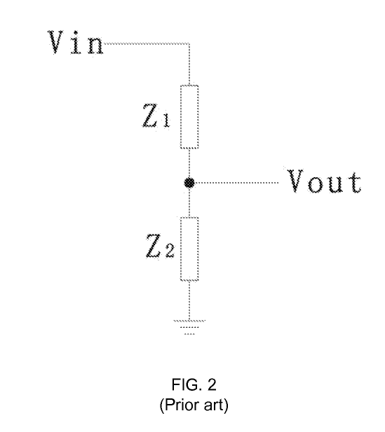

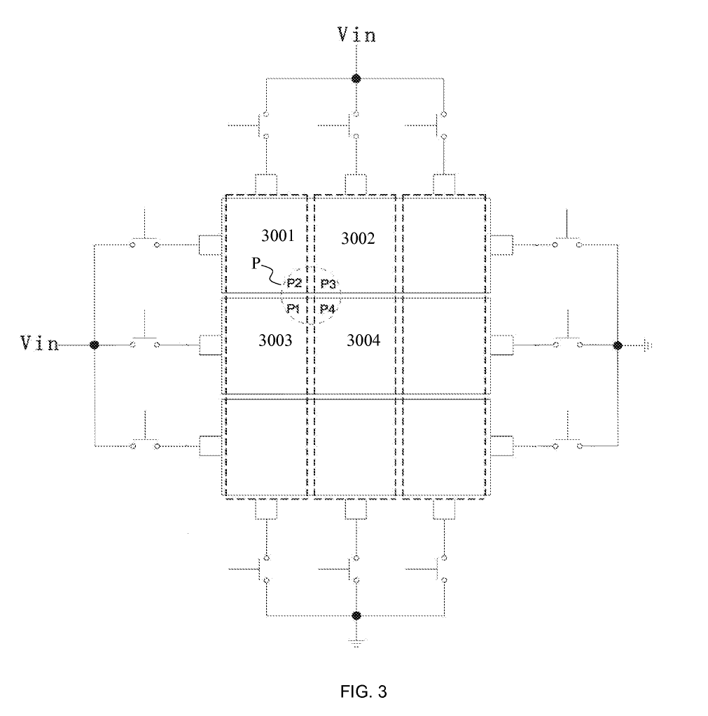

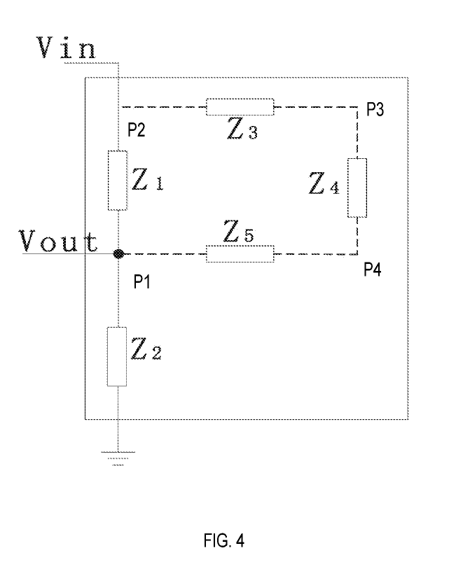

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In this regard, although example embodiments may be described herein in the context of a touch screen or touch-screen panel, it should be understood that the touch screen or touch-screen panel may but need not include an integral display. Also, for example, references may be made herein to axes, directions and orientations including X-axis, Y-axis, vertical, horizontal, diagonal, right and/or left; it should be understood, however, that any direction and orientation references are simply examples and that any particular direction or orientation may depend on the particular object, and/or the orientation of the particular object, with which the direction or orientation reference is made. Like numbers refer to like elements throughout.

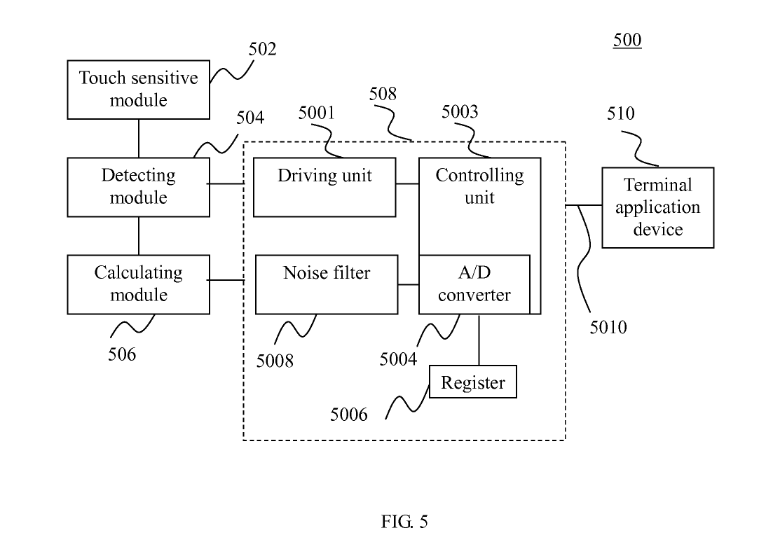

FIG. 5 illustrates a schematic diagram of a touch-screen panel 500 according to an exemplary embodiment of the present invention (“exemplary” as used herein referring to “serving as an example, instance or illustration”). As explained below, the touch-screen panel 500 may be configured to produce values corresponding to coordinates of a touch position on a touch-sensitive surface. The touch-screen panel 500 may be configured to provide these coordinates and other related information to a terminal application device 510, which may be configured to interact with the terminal application device based on the touch position, such as by viewing data from the coordinate detection. The terminal application device may be any of a number of different processing devices including, for example, a laptop computer, desktop computer, server computer, or a portable electronic devices such as a portable music player, mobile telephone, portable digital assistant (PDA), tablet or the like. Generally, the terminal application device may include a processor, memory, user interface (e.g., display and/or user input interface) and/or one or more communication interfaces.

The touch-screen panel 500 may include a touch-sensitive surface or module 502, a detecting module 504, a calculating module 506, and a processor, microcontroller 508 or the like. The touch-sensitive module 502 may include a touch-sensitive surface with a plurality of touch-sensitive units. When a user's finger or a stylus is placed on the touch screen, the touch-sensitive module 502 may generate an induction signal induced by the contact. The contact may be applied to one, or two or more touch-sensitive units. The detecting module 504 may determine the number of touch-sensitive units to which the contact is applied. In an instance in which the contact is applied to two or more touch-sensitive units, each of the respective touch-sensitive units may generate a respective induction signal. In this case, the calculating module 506 may combine the generated induction signals into a single signal, which may be referred as a “touch signal.” For an instance, when the contact is received in between at least two adjacent touch-sensitive units, the contact may induce the respective touch-sensitive units and may generate respective induction signals. For example, first and second adjacent touch-sensitive units may generate respective first and second induction signals. Each of the induction signals may be associated with a position of the point of contact on the respective touch-sensitive unit, and as such, each of the induction signals may include an X coordinate in the horizontal direction and a Y coordinate in the vertical direction. The calculating module 506 may combine X coordinate of the first and second induction signals and combine Y coordinate of the first and second induction signals to produce the touch signal.

As touch screens are often used in portable applications, the power consumption of the microcontroller may be taken into account. One way to reduce the power consumption is to enable the microcontroller enter a lower-power sleep mode when no activity is detected on the touch screen, and enter a higher-power operation mode when the touch screen is triggered by an activity. To enable the sleep mode function, level-change detection may be implemented by an interrupting unit (not shown) in the detecting module 504. This allows the microcontroller 508 to enter lower-power sleep mode while awaiting activity on the touch screen, and wake up when a change in the voltage level output by electrodes of the touch-sensitive units is detected. For instance, the electrodes may maintain a level that is higher than a pre-defined level when no activity is detected on the touch-sensitive module 502. When touch activity on the touch-sensitive module 502 is detected, the level of the electrodes may change, such as to a level lower than the pre-defined level. A signal representative of this level change may be sent to the microcontroller 508 as an interrupt signal. In various instances, the terminal application device 510 may also be configured to operate in sleep and operation modes, and in these instances, the microcontroller 508 may also forward the interrupt signal to the terminal application device 510 to thereby wake up the terminal application device.

The microcontroller 508 may include a driving unit 5001. The driving unit 5001 may independently power both X and Y coordinates of the touch-screen panel to ON or OFF. The driving unit 5001 may provide the X and Y coordinates of the touch position and status information (e.g., operation mode and sleep mode) to a controlling unit 5003 of the microcontroller 508. An analog-to-digital (A/D) converter 5004 of the microcontroller 508 may measure the touch position and voltage of the applied pressure, such as by converting the analog voltage from the touch screen into one or more corresponding digital values. The digital values may be stored in a memory or a register 5006. To minimize noise signals (e.g., from a display), the microcontroller 508 may also include a noise filter 5008. In one example, capacitors may be added from the driving unit 5001 to ground, thereby forming a low-pass noise filter. Digitalized values corresponding to coordinates of the touch position and status information may be transmitted through a bus 5010 (e.g., an RS232 interface or Universal Serial Bus) to enable the user to view data from the coordinate detection. The information may be viewed with the display of the terminal application device 510.

As described herein, the touch-sensitive module 502 and microcontroller 508 (and memory) are implemented in hardware, alone or in combination with software or firmware. Likewise, the terminal application device 510 (e.g., computer) includes hardware configured to operate alone or in combination with software or firmware. The driving unit 5001, controlling unit 5003, A/D converter 5004, register 5006 and noise filter 5008 may each be implemented in hardware, software or firmware, or some combination of hardware, software and/or firmware. Similarly, the detecting module 504 and calculating module 506 may each be implemented in hardware, software or firmware, or some combination of hardware, software and/or firmware. In instances in which the detecting module 504 or calculating module 506 are implemented in software or firmware, the microcontroller 508 may operate the respective software or firmware to carry out the functions of the detecting module 504 or calculating module 506.

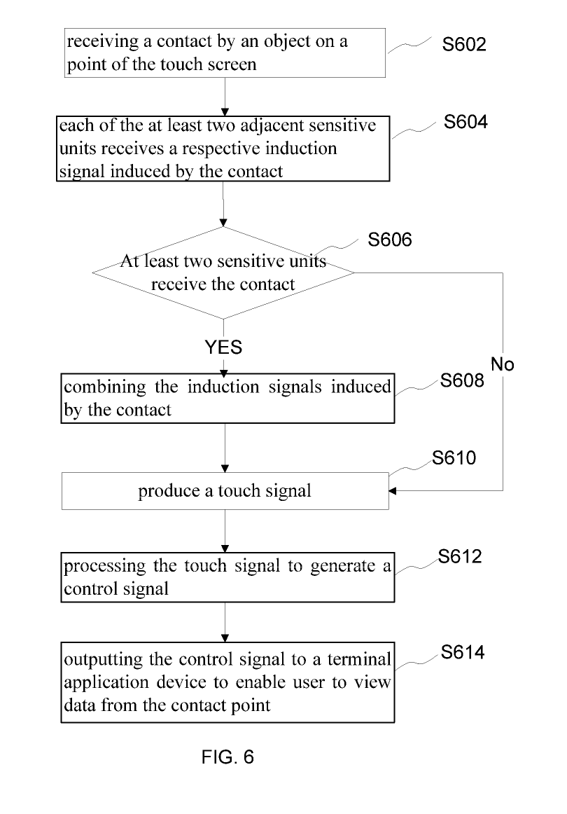

FIG. 6 is a flow chart describing a method of detecting a touch on a touch-screen panel according to one exemplary embodiment of the present invention. When a user or a stylus contacts and applies pressure to a point on the touch screen, the touch-sensitive module 502 may sense the contact at step S602. In an instance in which the contact is received in between at least two adjacent touch-sensitive units, the contact may induce the respective touch-sensitive units and may generate respective induction signals at step S604. For example, first and second adjacent touch-sensitive units may generate respective first and second induction signals. Each of the induction signals may be associated with a position of the point of contact on a respective touch-sensitive unit, and as such, each of the induction signals may include an X coordinate in the horizontal direction and a Y coordinate in the vertical direction. The detecting module 504 may determine whether the user or stylus contacts one or multiple touch-sensitive units of the touch-sensitive module 502 at step S606.

The calculating module 506 may combine the X and Y coordinates of the induction signals at step S608. The combination of the first and second induction signals may produce a touch signal at step S610. In another instance in which the detecting module 504 determines that the user or stylus contacts a single touch-sensitive unit (a “NO” is yielded at step S606), the touch signal produced at step S610 may be based on an induction signal induced by the contact on the single touch-sensitive unit.

The touch signal produced by the calculating module 506 may be provided to the microcontroller 508, which may receive and process the touch signal at step S612. The touch signal associated with the touch position may be converted from analog voltages into digital values by the A/D converter 5004. To minimize noise signals, the touch signal may be filtered by the noise filter 5008, such as before its conversion by the A/D converter 5004. After processing the touch signal, the microcontroller 508 may output the processed signal as a control signal to the terminal application device 510 at step S614. The terminal application device 510 may then display data from the contact point.

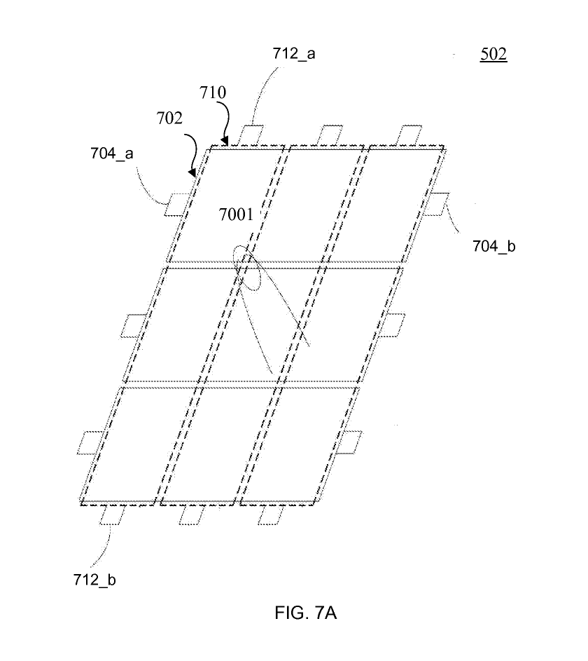

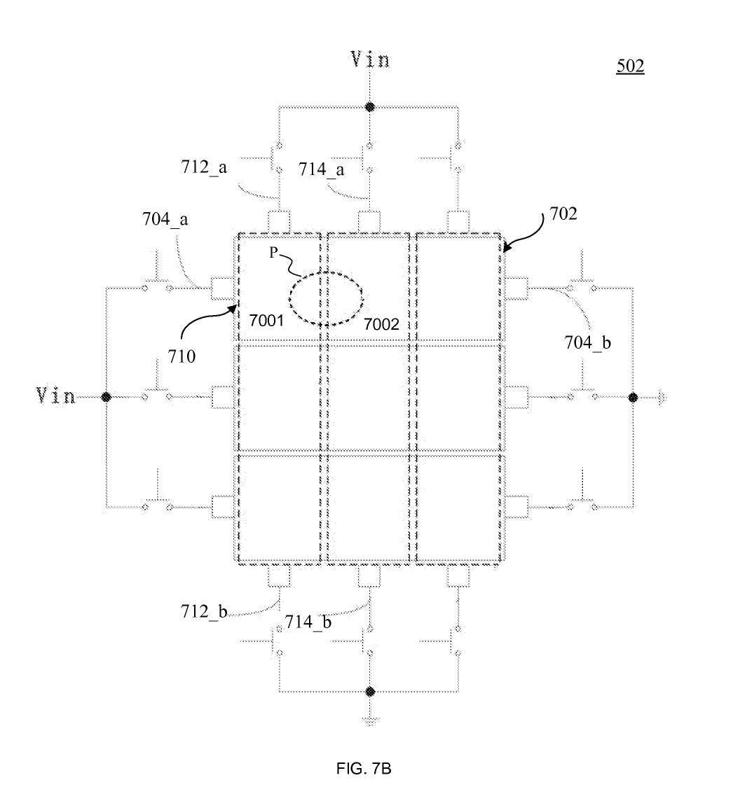

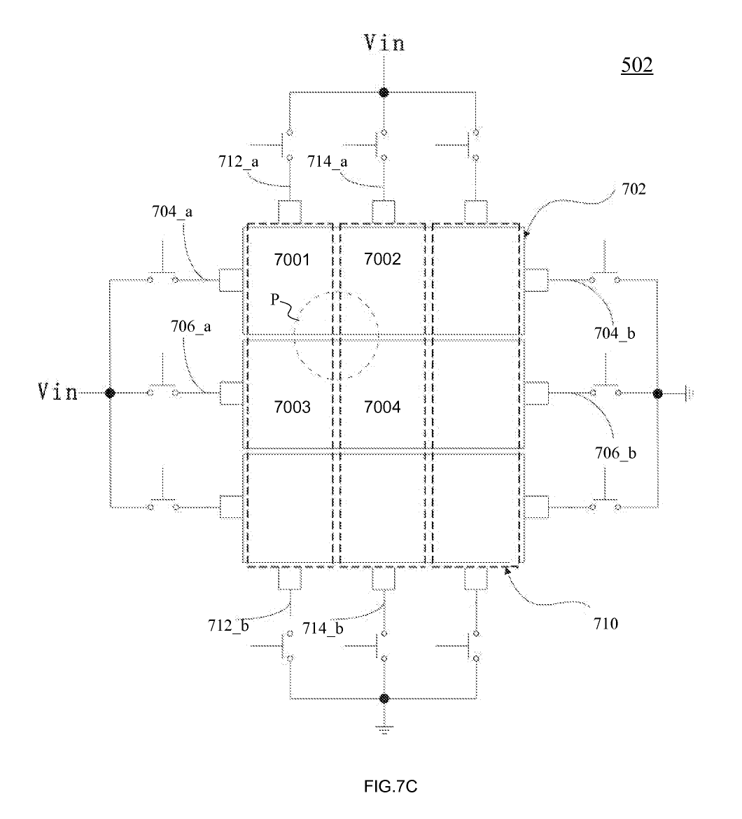

FIG. 7A illustrates a touch point across multiple touch-sensitive units on a touch-screen panel 500 according to one exemplary embodiment of the present invention. The touch-screen panel 500 may include a touch-sensitive module 502, which in the example of FIG. 7A may be a resistive touch-sensitive module. The touch-sensitive module 502 includes a touch-sensitive surface with a plurality of touch-sensitive units (not numbered). Each of the touch-sensitive units, such as touch-sensitive unit 7001, from top to bottom, includes a first transparent layer (not shown), a first conductive layer 702, an air-gap (not numbered), a second transparent layer (not shown), and a second conductive layer 710. When the touch-screen panel is not under an applied pressure, the air-gap keeps the first and second conductive layers apart. When a user touches surface of the touch screen with a stylus or a finger, the pressure of the stylus or finger causes the first conductive layer 702 to deform, allowing the first and second conductive layers to connect. In this manner, power may be applied to one of the first and second conductive layers through electrodes (e.g., 704_{—}a to 704_{—}b, or 712_{—}a to 712_{—}b) at opposing ends of that layer. The connection of the first and second conductive layers causes a change in electrical current or voltage, which is registered as an event, or an interrupt signal, and sent to the microcontroller 508 for processing.

FIG. 7B illustrates a schematic diagram of a touch point across multiple touch-sensitive units on a touch-screen panel 500 according to one exemplary embodiment of the present invention. The electrodes (e.g., 704_{—}a, 712_{—}a, and 714_{—}a) may maintain a level that is higher than a pre-defined level when no activity is detected on the touch-sensitive module 502. When touch activity on the touch-sensitive module 502 is detected, the corresponding switch(es) may be closed. The voltage level of respective electrodes is accordingly changed. In the exemplary embodiment as shown in FIG. 7B, a user or stylus touches a point P across multiple touch-sensitive units, such as touch-sensitive units 7001 and 7002. In this manner, the switches coupled to the electrodes that are associated with the touch point P, such as the electrodes 704_{—}a to 704_{—}b, 712_{—}a to 712_{—}b and 714_{—}a to 714_{—}b, are closed. The calculating module 506 may then process a combination procedure as described above. The voltage level of the electrodes 704_{—}a, 712_{—}a and 714_{—}a are accordingly changed, such as to a level lower than the pre-defined level. As explained above, measurements of X-Y positions of the touch point are conducted in a similar manner to a resistive voltage divider. In this instance, when a supply voltage Vᵢₙ is applied to the first conductive layer 702 from the X-axis electrodes 704_{—}a to 704_{—}b, X position of the touch point may be measured by the output voltage Vₒᵤₜ between the Y-axis electrodes 712_{—}a and 712_{—}b, and between the Y-axis electrodes 714_{—}a and 714_{—}b on the second conductive layer 710. Similarly, when a supply voltage Vᵢₙ is applied to the second conductive layer 710 from the Y-axis electrodes 712_{—}a to 712_{—}b and 714_{—}a to 714_{—}b, Y position of the touch point may be measured by the output voltage Vₒᵤₜ between the X-axis electrodes 704_{—}a and 704_{—}b on the first conductive layer 702.

FIG. 7C illustrates a schematic diagram of a touch point across multiple touch-sensitive units on a touch-screen panel according to another exemplary embodiment of the present invention. In this instance, a user or stylus may touch a point P across four touch-sensitive units, such as 7001, 7002, 7003 and 7004. The switches coupled to the electrodes that are associated with the touch point P (e.g., the electrodes 704_{—}a to 704_{—}b, 706_{—}a to 706_{—}b, 712_{—}a to 712_{—}b and 714_{—}a to 714_{—}b) are closed. The calculating module 506 may then process a combination procedure as described above. The voltage level of the X-axis electrodes 704_{—}a, 706_{—}a, and Y-axis 712_{—}a and 714_{—}a are accordingly changed, such as to a level lower than a pre-defined level. When a supply voltage Vᵢₙ is applied to the first conductive layer 702 from the X-axis electrodes 704_{—}a to 704_{—}b or 706_{—}a to 706_{—}b, X position of the touch point may be determined by the output voltage Vₒᵤₜ between the Y-axis electrodes 712_{—}a and 712_{—}b, and between the Y-axis electrodes 714_{—}a and 714_{—}b on the second conductive layer 710. Similarly, when a supply voltage Vᵢₙ is applied to the second conductive layer 710 from the Y-axis electrodes 712_{—}a to 712_{—}b and 714_{—}a to 714_{—}b, Y position of the touch point may be determined by the output voltage Vₒᵤₜ between the X-axis electrodes 704_{—}a and 704_{—}b, and between the X-axis electrodes 706_{—}a and 706_{—}b on the first conductive layer 702. According to one aspect of the example embodiments of present invention, the functions performed by the touch-screen panel 500, such as those illustrated by the block diagram of FIG. 5, and the flow chart of FIG. 6, may be performed by various means, such as the microcontroller 508. It will be understood that each block or operation of the block diagram or flowchart, and/or combinations of blocks or operations in the block diagrams or flowchart, can be implemented by various means. Means for implementing the blocks or operations of the block diagrams or flowchart, combinations of the blocks or operations in the block diagrams or flowchart, or other functionality of example embodiments of the present invention described herein may include hardware, and/or a computer program product including a tangible and non-transitory computer-readable storage medium having one or more computer program code instructions, program instructions, or executable computer-readable program code instructions stored therein. In this regard, program code instructions may be stored on a memory device, such as the register 5006 of the example apparatus, and executed by a processor, such as the microcontroller 508 of the example apparatus. That is, example embodiments of the present invention may include a computer-readable storage medium having computer-readable program code portions stored therein. The computer-readable storage medium and computer-readable program code portions may be configured to, with at least one processor, cause an apparatus to perform any one or more of the methods or operations of the methods described herein.

As will be appreciated, any such program code instructions may be loaded onto a computer or other programmable apparatus (e.g., processor, memory device, or the like) from a computer-readable storage medium to produce a particular machine, such that the particular machine becomes a means for implementing the functions specified in the functional block diagram's or flowchart's block(s) or operation(s). These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the functional block diagram's or flowchart's block(s) or operation(s). The program code instructions may be retrieved from a computer-readable storage medium and loaded into a computer, processor, or other programmable apparatus to configure the computer, processor, or other programmable apparatus to execute operations to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the functional block diagram's or flowchart's block(s) or operation(s).

Accordingly, execution of instructions associated with the blocks or operations of the block diagrams or flowchart by a processor (e.g., microcontroller 508), or storage of instructions associated with the blocks or operations of the flowcharts in a computer-readable storage medium, supports combinations of operations for performing the specified functions. It will also be understood that one or more blocks or operations of the flowcharts, and combinations of blocks or operations in the flowcharts, may be implemented by special purpose hardware-based computer systems and/or processors which perform the specified functions, or combinations of special purpose hardware and program code instructions.

It will be appreciated by those skilled in the art that changes could be made to the examples described above without departing from the broad inventive concept. It is understood, therefore, that this invention is not limited to the particular examples disclosed, but it is intended to cover modifications within the spirit and scope of the present invention as defined by the appended claims.

What is claimed is:

1. A method of detecting a contact on a touch-screen panel including a plurality of touch-sensitive units arranged on a touch-sensitive surface, the method comprising:
receiving at least two induction signals induced by a contact of an object with the touch-sensitive surface at a point in between at least two adjacent touch-sensitive units, the at least two adjacent touch-sensitive units including a first touch-sensitive unit and a second touch-sensitive unit, the at least two induction signals including a first induction signal induced by contact with the first touch-sensitive unit and a second induction signal induced by contact with the second touch-sensitive unit;
combining the first and second induction signals to produce at least part of a touch signal;
processing the touch signal to generate a control signal; and
outputting the control signal to a terminal application device to enable user to view data from the contact point.

2. The method of claim 1, wherein processing the touch signal to generate a control signal and outputting the control signal are performed by a microcontroller, and wherein the method further comprises:
generating an interrupt signal in response to receipt of the at least two induction signals to enable the microcontroller to exit a sleep mode and enter an operation mode.

3. The method of claim 1 further comprising:
generating an interrupt signal in response to receipt of the at least two induction signals; and
outputting the interrupt signal to enable the terminal application device to exit a sleep mode and enter an operation mode.

4. The method of claim 1, combining the first and second induction signals includes combining a first direction signal of each induction signal, and combining a second direction signal of each induction signal to produce at least part of the touch signal.

5. The method of claim 1, processing the touch signal to generate a control signal includes filtering noise from the touch signal.

6. The method of claim 1, processing the touch signal to generate a control signal includes converting the touch signal from an analog signal to a digital signal.

7. The method of claim 1, processing the touch signal includes storing position information of the point of contact in a memory.

8. The method of claim 1, outputting the control signal to a terminal application device includes transmitting at least part of the control signal to the terminal application device via one of an RS232 interface or Universal Serial Bus.

9. A touch screen panel, comprising:
a touch-sensitive module including a plurality of touch-sensitive units arranged on a touch-sensitive surface, the touch-sensitive module configured to receive at least two induction signals induced by a contact of an object with the touch-sensitive surface at a point in between at least two adjacent touch-sensitive units including a first touch-sensitive unit and a second touch-sensitive unit, the at least two induction signals including a first induction signal induced by contact with the first touch-sensitive unit and a second induction signal induced by contact with the second touch-sensitive unit;
a calculating module configured to combine the first and second induction signals to produce a touch signal; and
a microcontroller configured to process the touch signal to generate a control signal and output the control signal to a terminal application device to enable user to view data from coordinates of the contact point.

10. The touch-screen panel of claim 9, further comprising a detecting module configured to determine whether at least two touch-sensitive units are contacted by the object.

11. The touch-screen panel of claim 10, wherein the detecting module is future configured to generate an interrupt signal in response to receipt of the at least two induction signal, output the interrupt signal to enable at least one of the microcontroller or the terminal application device to exit a sleep mode and enter an operation mode.

12. The touch-screen panel of claim 9, wherein the microcontroller further comprises a noise filter configured to filter noise from the touch signal.

13. The touch-screen panel of claim 9, wherein the microcontroller further comprises an analog-to-digital (A/D) converter configured to convert an analog signal to a digital signal.

14. The touch-screen panel of claim 9, wherein the microcontroller further comprises a driving unit configured to power X or Y coordinates of the touch-screen panel to ON or OFF and provide at least one of the X or Y coordinates of the contact position or status information to a controlling unit.

15. The touch-screen panel of claim 9, wherein the microcontroller further comprises a controlling unit configured to receive at least one of X or Y coordinates of the contact position or status information.

16. The touch-screen panel of claim 9, wherein the calculating module is further configured to combine X coordinates of the first and second induction signals, and combine Y coordinates of the first and second induction signals to produce at least part of the touch signal.

17. The touch-screen panel of claim 9, wherein the microcontroller further comprises a register for storing position information of the point of contact.

18. The touch-screen panel of claim 9 further comprises an interface between the microcontroller and the terminal application device, wherein the interface comprises one of an RS232 interface or Universal Serial Bus.
